(19) United States
(12) Patent Application Publication
(10) Pub. No.: US 2020/0411847 A1
(43) Pub. Date: Dec. 31, 2020

(54) POLYMER BATTERY FORMED FROM FREESTANDING ELECTRODE FILMS

(71) Applicant: Sumitomo Chemical Company Limited, Tokyo (JP)

(72) Inventors: Thomas Johannes Kugler, Cambridge (GB); Jonathan Toner, Newry, Co.down (IE); Melanie O''Sullivan, Godmanchester (GB)

(73) Assignee: Sumitomo Chemical Company Limited, Tokyo (JP)

(21) Appl. No.: 16/978,631

(22) PCT Filed: Mar. 4, 2019
(86) PCT No.: PCT/EP2019/055349

§ 371 Date: Sep. 4, 2020

(30) Foreign Application Priority Data
Mar. 8, 2018 (GB) 1803738.2
Mar. 8, 2018 (GB) 1803743.2

(51) Int. Cl. H01M 4/137; H01M 10/0525; H01M 4/62; H01M 10/0569; H01M 4/1399

(52) U.S. Cl. CPC H01M 4/137; H01M 10/0525; H01M 4/1399; H01M 10/0569; H01M 4/625

(57) ABSTRACT

A freestanding composite electrode film is made of an n-type or p-type electrochemically active polymer an electrolyte and/or a conductive carbon material. The freestanding composite electrode film may be used to form an anode or cathode layer of a polymer battery. The polymer battery may be formed from a stack/plurality of anode or cathode layers, each layer being formed from a freestanding composite electrode film.

### BACKGROUND

Embodiments of the present disclosure relate to polymer battery cells, freestanding electrode layers/films for use therein and polymer batteries formed from stacks of the freestanding electrode layers/films.

Use of a conjugated polymer in the anode or cathode of a polymer-based battery cell is disclosed in, for example, Journal of Power Sources, Volume 177, Issue 1, 15 Feb. 2008, Pages 199-204, in Chem. Rev. 2016, 116, 9438-9484 and in Chemical Reviews, 1997, Vol. 97, No. 1 209.

United States Patent Pub. No. 2017/0200565 discloses a supercapacitor electrode comprising a solid graphene foam impregnated with a liquid or gel electrolyte.

United States Patent Pub. No. 2017/148573 discloses a process for producing an electrode for a supercapacitor cell.

United States Patent Pub. No. 2017/098856 discloses a process for producing a lithium battery.

### SUMMARY

According to some embodiments of the present disclosure, a method for forming electrodes of a polymer battery, and a polymer battery containing said electrodes is provided.

The present inventors have found that depositing a suspension of electrode materials in a solvent or solvent mixture onto a current collector followed by evaporation of the solvent or solvents may result in delamination or cracking of the resulting electrode. The present inventors have found that this may be avoided by forming the electrode from an electrode layer formed from one or more freestanding electrode films.

In some embodiments, there is provided a freestanding composite electrode film comprising 25-90 wt % of an n-type or p-type electrochemically active polymer and at least one of an electrolyte and a conductive carbon material.

In some embodiments, there is provided a method of forming a freestanding composite electrode film, the method comprising the step of depositing a formulation comprising the n-type or p-type electrochemically active polymer and one or both of the electrolyte and the conductive carbon material dissolved or dispersed in one or more solvents onto a surface of a film forming substrate; evaporating the solvent or solvents to form a film; and separating the film from the film forming substrate.

In some embodiments, there is provided a method of forming a battery comprising an anode comprising an n-type polymer, a cathode comprising a p-type polymer; a separator between the anode and the cathode; an anode current collector; and a cathode current collector, wherein at least one of the anode and cathode comprises at least one anode or cathode layer formed by lamination of, respectively, a freestanding composite anode or cathode film according to the first aspect.

In some embodiments, the or each anode or cathode layer may be formed by laminating the freestanding composite anode or cathode film to the anode or cathode current collector, the separator or another freestanding composite anode or cathode film.

In some embodiments, a battery is provided that may be formed using the freestanding composite electrode films.

In some embodiments, a battery is provided comprising an anode comprising an n-type polymer, a cathode comprising a p-type polymer; a separator between the anode and the cathode; an anode current collector; and a cathode current collector, wherein at least one of the anode and cathode comprises an electrode stack comprising a plurality of electrode layers, each electrode layer comprising 25-90 weight % of an n-type or p-type electrochemically active polymer and at least one of an electrolyte and a conductive carbon material. Each electrode layer may be formed from a freestanding composite electrode film as described herein.

In some embodiments, a freestanding composite electrode film comprising an n-type or p-type electrochemically active polymer and at least one of an electrolyte and a conductive carbon material dispersed in the polymer. The freestanding composite electrode film may be formed as described herein and may be used in a method of forming a battery.

By “freestanding electrode film” or “freestanding electrode layer” as used herein is meant an electrode film/layer which is not attached to or supported by another structure.

By “lamination” as used herein is meant bringing two or more layered structures into contact with one another to form a laminate structure, wherein each layered structure comprises at least one layer. The process of lamination may or may not include application of heat and/or pressure when the separate layers are brought into contact or after the separate layers have been brought into contact.

The present inventors have further found that depositing a suspension of electrode materials in a solvent or solvent mixture onto a current collector followed by evaporation of the solvent or solvents may result in delamination or cracking of the resulting electrode. The present inventors have found that this may be avoided by forming an electrode from a stack of electrode layers, such as described herein.

In some embodiments, an intermediate electrolyte layer between adjacent electrode layers of the electrode stack may be used to significantly enhance performance of the battery, even if the electrode layers sandwiching the intermediate electrolyte layer contain the same electrolyte as the electrolyte layer.

Accordingly, in some embodiments, a polymer battery is provided comprising an anode, a cathode; and a separator between the anode and the cathode wherein: at least one of the anode and cathode comprises a plurality of electrode layers and an intermediate electrolyte layer between two of the plurality of electrode layers; each anode electrode layer comprises an n-type polymer; each cathode electrode layer comprises a p-type polymer; and each intermediate electrolyte layer comprises a polymer and an electrolyte.

In some embodiments, a method of forming a battery is provided where at least one of the anode and cathode is formed by deposition of a formulation comprising the polymer and electrolyte of the intermediate electrolyte layer on a surface of a first one of a pair of electrode layers; and forming the other of pair of electrode layers on the intermediate electrolyte layer.

In some embodiments, the polymer batteries comprise rechargeable batteries.

### DESCRIPTION OF THE DRAWINGS

The invention will now be described in more detail with reference to the drawings in which:

FIG. 1A illustrates a polymer battery cell, according to some embodiments of the present disclosure;

FIG. 1B illustrates a polymer battery cell, according to some embodiments of the present disclosure;

FIG. 2 illustrates a flexible polymer battery, according to some embodiments of the present disclosure; and

FIG. 3 illustrates a method of forming a flexible polymer, according to some embodiments of the present disclosure;

FIG. 4 is a plot of charge capacity vs. cycle number for batteries containing two different n-type polymers and a battery containing only one n-type polymer;

FIGS. 5A-5C are discharge curves for, respectively, a battery with only one n-type polymer in the anode; a battery with two different n-type polymers in a 90:10 weight ratio in the anode;

and a battery with two different n-type polymers in a 80:20 weight ratio in the anode;

FIG. 6 is a plot of discharge voltage vs. time for a battery comprising an electrode formed from a stack of electrode layers with an intermediate electrolyte layer between adjacent electrode layers, according to some embodiments of the present disclosure;

FIG. 7 is a plot of midpoint voltage vs. cycle number for batteries comprising an electrode formed from a stack of electrode layers with an intermediate electrolyte layer between adjacent electrode layers, according to embodiments having electrolyte layers of differing molecular weight;

FIG. 8 is a plot of charge capacity vs. cycle number for batteries comprising an electrode formed from a stack of electrode layers with an intermediate electrolyte layer between adjacent electrode layers, according to embodiments having electrolyte layers of differing molecular weight; and

FIG. 9 is a plot of voltage vs charge capacity for a flexible battery comprising an electrode formed from a stack of electrode layers with an intermediate electrolyte layer between adjacent electrode layers, according to some embodiments of the present disclosure.

### DETAILED DESCRIPTION

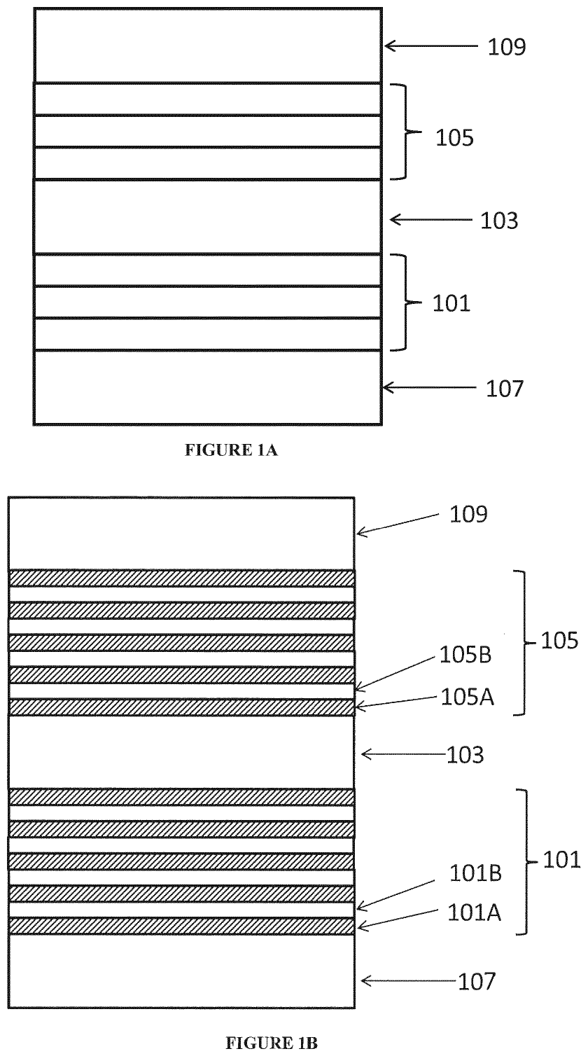

FIG. 1A, which is not drawn to any scale, illustrates a battery cell 100 according to an embodiment comprising an anode 101, a cathode 105, a separator 103 between the anode and the cathode, an anode current collector 107 in contact with the anode and a cathode current collector 109 in contact with the cathode.

The anode comprises at least one electrochemically active polymer which is capable of undergoing reversible n-doping (an “n-type” polymer). n-type polymers as described herein preferably have a LUMO level measured by square wave voltammetry of between −4.5 and −1.5 eV, more preferably between −3.5 and −2.0 eV

The cathode comprises at least one electrochemically active polymer which is capable of undergoing reversible p-doping (a “p-type” polymer). The p-type polymers as described herein preferably have a HOMO level measured by square wave voltammetry of between −4.5 and −6.5 eV, more preferably between −4.8 and −6 eV.

At least one of the anode and cathode of the battery cell contains at least one electrode layer formed from a freestanding electrode film. Accordingly, the anode 101 of the battery cell comprises or consists of one or more anode layers, each anode layer being formed from a freestanding anode layer, and/or the cathode 105 of the battery cell comprises or consists of one or more cathode layers, each cathode layer being formed from one or more freestanding cathode layers.

The anode 101 and cathode 105 illustrated in FIG. 1A each contain three electrode layers, however it will be understood that each electrode may contain more or fewer electrode layers and the number of anode layers may be the same as or different from the number of cathode layers. The number of electrode layers may be selected according to, for example, a desired cell capacity. Preferably, the number of electrode layers is in the range of 1-15, optionally 1-10 or 1-6. An electrode containing at least one electrode layer formed from a freestanding electrode film as described herein preferably has a thickness in the range of 10-100 microns, optionally 25-90 microns. An anode or cathode stack containing a plurality of electrode layers may be formed to a desired electrode thickness without cracking of the electrode as for an electrode formed by deposition of a formulation onto a current collector followed by evaporation of solvent(s).

The anode 101 and cathode 105 illustrated in FIG. 1A each contain a plurality of electrode layers formed from freestanding electrode films. In other embodiments, one of the anode and cathode does not comprise any electrode layers formed from freestanding electrode films.

For example, one of the anode and cathode may be formed by depositing onto a current collector a formulation containing the components of the electrode dissolved or dispersed in one or more solvents followed by evaporation of the one or more solvents.

FIG. 1B, which is not drawn to any scale, illustrates a battery cell 100 according to some embodiment comprising an anode 101, a cathode 105, a separator 103 between the anode and the cathode, an anode current collector 107 in contact with the anode and a cathode current collector 109 in contact with the cathode.

In FIG. 1B, each of the anode and cathode is a stack comprising a plurality of electrode layers wherein each electrode layer comprises an n-type polymer (in the case of an anode layer 101A) or a p-type polymer (in the case of a cathode layer 105A).

An intermediate electrolyte layer is disposed between at least one pair of adjacent electrode layers in the stack, and preferably between each pair of adjacent electrode layers as illustrated in FIG. 1B in which gel electrolyte layer 101B is disposed between each pair of adjacent anode layers 101A and wherein gel electrolyte layer 105B is disposed between each pair of adjacent cathode layers 105A. Accordingly, an anode or cathode as described herein comprises two or more electrode layers (at least one electrode pair) and one or more intermediate electrolyte layers.

It will be appreciated that two pairs of adjacent electrode layers as described herein may have one common electrode layer; thus, a stack containing three electrode layers contains two pairs of adjacent electrode layers including one electrode layer common to both pairs.

It will be appreciated that a pair of adjacent electrode layers do not directly contact one another across at least part or all of their surface areas if an intermediate electrolyte layer is provided therebetween.

For simplicity, FIG. 1B illustrates adjacent electrode pairs which do not contact one another at all due to intervening gel electrolyte layers 101B and 105B, however it will be appreciated that at least some of the surfaces of adjacent electrode pairs may be in direct contact and optionally a majority of the overlapping surfaces of adjacent electrode pairs may be in direct contact. It will therefore be appreciated that the intermediate electrolyte layer as described herein may be a discontinuous layer and/or a layer containing one or more apertures.

An electrode containing adjacent electrode layers which are in direct contact may have enhanced electrical conductivity (as distinct from ionic conductivity) as compared to an electrode in which adjacent electrode layers which are not in direct contact. The extent of direct contact between adjacent electrode layers may be determined, at least in part, by the average thickness of the intermediate electrolyte layer and/or the extent of crosslinking of a gel electrolyte layer.

Preferably, the intermediate electrolyte layer is in direct contact with a surface of each electrode layer of the electrode pair.

For each of the anode and cathode, an electrode layer or an electrolyte layer of the electrode stack may be in direct contact with the current collector. Preferably an electrode layer is in direct contact with the current collector.

For each of the anode and cathode, an electrode layer or an electrolyte layer of the electrode stack may be in direct contact with the separator. Preferably an electrode layer is in direct contact with the separator. It will be appreciated that an electrolyte layer which is in contact with a current collector or a separator is not an intermediate electrolyte layer in that it is not between two electrode layers.

The anode 101 and cathode 105 illustrated in FIG. 1B each contain 5 electrode layers and 4 gel electrolyte layers, however it will be understood that each electrode may contain more or fewer electrode layers (and more or fewer gel electrolyte layers) and the number of anode layers may be the same as or different from the number of cathode layers. The number of electrode layers may be selected according to, for example, a desired cell capacity.

The anode 101 and cathode 105 illustrated in FIG. 1B each contain electrode layers and gel electrolyte layers however in other embodiments only one of the anode and cathode comprises a plurality of electrode layers and gel electrolyte layers. In these other embodiments, the other of the anode and cathode may consist of a single composite electrode layer.

The battery described herein, including those described in FIGS. 1A & 1B may, in accordance with some embodiments, comprise a flexible battery, for example a battery capable of bending to give a circular arc of at least 10°, optionally at least 20° or 40°.

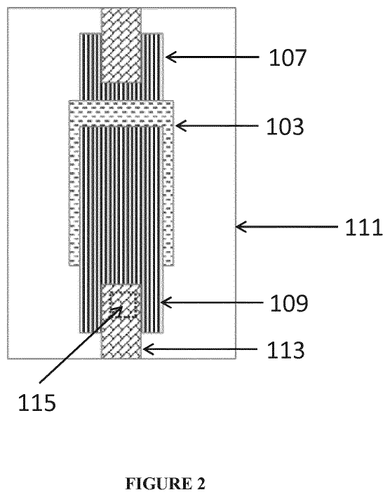

An exemplary flexible battery is illustrated in FIG. 2, which is not drawn to any scale, in which the battery has flexible anode and cathode current collectors 107, 109 for example metal foil current collectors. The separator 103 has a perimeter dimension (length or width) which is at least the same as that of the current collectors, preferably greater than that of the current collectors. Any parts of the two current collectors which fall outside the separator perimeter are arranged such that they do not contact one another, for example during flexing or lamination of the device.

The flexible battery may be sealed in flexible packaging 111. The flexible packaging may be formed by sealing the device in a flexible pouch or between two flexible sheets. The flexible packaging may be sealed by passing the packaging enclosing the two flexible sheets through a lamination machine. Apertures 115 in the flexible packaging expose the anode and cathode current collectors for connection to conductive lead-outs 113, suitably flexible lead-outs, for example metal tape such as copper tape or aluminium tape or a printed metal ink, for example printed silver ink.

Anode and cathode lead-outs 113 illustrated in FIG. 2 are on opposite ends of the same side of the battery, however it will be appreciated that lead-outs as described anywhere herein may have other arrangements, for example on opposing sides of the battery.

A lamination machine as described anywhere herein comprises two rollers through which a flexible structure may be passed. Preferably, the rollers are heated when in use.

The flexible anode and cathode current collectors of a flexible battery may be laminated together so as to encapsulate the device. An insulating layer may be provided on a surface of at least one of the flexible current collectors outside an area occupied by the anode, cathode and separator to avoid a short circuit between the two current collectors arising from lamination of the current collector.

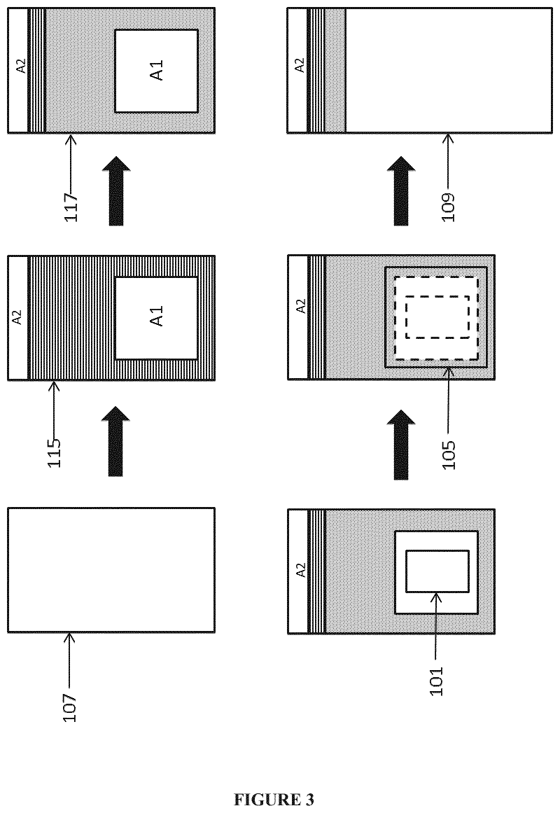

FIG. 3, which is not drawn to any scale, illustrates a process of forming a battery encapsulated by its current collectors.

A surface of anode current collector 107 of a metal foil (denoted in FIG. 3 as the ‘N’ current collector) is covered by an insulating layer 115 of an insulating material, for example an adhesive insulating tape to define an exposed battery area A1 surrounded by the insulating material. The whole of the surface of the metal foil may be covered except for battery area A1. In other embodiments, and in addition to battery area A1, a lead-out area A2 is not covered by the insulating layer to allow for connection of lead-outs to the battery. A lead out area A2 may be provided on the same surface as battery area A1 if, for example, the opposing surface of the metal foil has an insulating backing such as PET-backed aluminium foil.

An adhesive layer 117, for example a layer of pressure-sensitive adhesive, is provided on the insulating layer. In other embodiments, the insulating layer 115 as applied to the anode current collector 107 may carry an adhesive backing layer. The anode 101 is placed within the battery area A1. A separator 103 is provided over the anode. The separator may be a cellulose-based filter paper, or a thin porous polymer sheet. The separator is soaked in electrolyte. The separator overlaps battery area A1, and preferably extends beyond the perimeter of battery area A1. A cathode 105 is disposed over the separator so as to at least partially or completely overlap with the underlying anode, and a metal foil cathode current collector 109 is applied over and around battery area A1. In other embodiments, two or all three of the anode, cathode and separator may be combined and then applied to the anode current collector 107. Cathode current collector 109 may or may not have an insulating layer and/or adhesive layer defining an exposed battery area A1, which may be the same as or different from battery area A1, and/or a lead-out area A2.

In some embodiments, the metal foil is the only encapsulant for the battery. In other embodiments, one or more further layers are provided on outer surfaces of the current collector metal foils. The one or more further layers may be a backing layer of the metal foil, particularly a polymer layer for example PET of PET-backed aluminium foil. The one or more further layers may be one or more encapsulating layers separate from the metal foil, such as flexible packaging as described with reference to FIG. 2. Use of metal foil without a separate encapsulation may allow for greater flexibility of the battery as compared to a battery with one or more further encapsulation layers.

In other embodiments, a flexible battery may be formed as described with respect to FIG. 3 except that the isolating layer defining aperture A1 is formed on cathode current collector 109 rather than anode current collector 107.

In other embodiments, a flexible battery may be formed as described with respect to FIG. 3 except that the insulating layer 115 is supported on a surface of one of the anode and cathode current collectors and the adhesive layer 117 surface is supported on a surface of the other of the anode and cathode current collectors.

In other embodiments, the anode, cathode and separator may be formed on a surface of a current collector which does not carry an insulating layer and the opposing current collector carries an insulating layer defining battery area A1 which is aligned with the electrode it is formed over when deposited thereover.

Freestanding Film Formation

A freestanding electrode film may be formed by depositing a formulation of the materials of the electrode layer dissolved or dispersed in a solvent or solvent mixture onto a surface of a substrate, hereinafter described as a film-forming substrate, followed by evaporation of the solvent or solvents. It will be understood that the formulation may contain one or more components which are not dissolved in the solvent or solvents. Preferably, the n-type or p-type polymer (or at least one of the n-type polymers or at least one of the p-type polymers if there is more than one of an n-type or p-type polymer in the formulation) is dissolved in the solvent or solvents. It will therefore be understood that the solvents as described herein do not necessarily dissolve all components of the formulation. Preferably, the solvent or solvent mixture dissolves an n-type polymer or a p-type polymer in the formulation. Exemplary solvents include, without limitation, cyclic ethers and aromatic solvents, preferably benzene, substituted with one or more substituents selected from C₁₋₁₀ alkyl; C₁₋₁₀ alkoxy; and halogens, optionally bromine or chlorine, such as o-dichlorobenzene; o-xylene; and anisole.

The film-forming substrate may be selected such that there is limited or no adhesion between the film-forming substrate and the formulation in order to limit or avoid cracking during the drying of the formulation. Preferably, the substrate is a glass or plastic substrate. The film-forming substrate may consist of a single material or it may comprise two or more materials, for example a first layer supporting a second layer having an outermost surface onto which the formulation is deposited. A material having high surface smoothness may be selected for use as the film-forming surface of the film-forming substrate.

The formulation may be dried at room temperature or it may be heated. The substrate may be heated before, during or after deposition of the formulation, for example by placing the substrate on a hotplate or in an oven. The heating temperature may be selected according to the boiling point of the solvent or solvents of the formulation. Optionally, heating is carried out at a temperature in the range of about 50-200° C., preferably about 50-100° C.

The formulation may be dried at atmospheric pressure or under reduced pressure. The freestanding electrode film may be subjected to a drying treatment as described herein before being used in a battery.

The freestanding electrode film is separated from the substrate following evaporation of the solvent or solvents. In embodiments, the electrode layer may partially or completely delaminate from the substrate during drying. Accordingly, it will be understood that “separating” the electrode layer from the substrate as used herein means removal of the electrode layer from contact with the substrate wherein the electrode layer following drying may or may not be adhered to the substrate surface. Preferably, freestanding electrode films as described herein have a thickness in the range of 10-100 microns, optionally 25-90 microns.

A freestanding electrode film as described herein may comprise or consist of one or more electrochemically active polymers and one or both of an electrolyte and conductive carbon. Optionally, the one or more electrochemically active polymers are the only polymers present in the freestanding electrode film. Freestanding electrodes as described herein may be stored in airtight and/or watertight packaging prior to use.

Electrode Layer Formation

In embodiments of the present disclosure, electrode layers as described herein may be formed from freestanding electrode films, such as described herein.

Intermediate Electrolyte Layer

In some embodiments, the anode/cathode may be formed of a stack of freestanding electrode layers, where the layers in the stack are separated by an intermediate electrolyte layer. The intermediate electrolyte layer comprises an ion-conducting polymer and an electrolyte dispersed therein. The intermediate electrolyte layer may be a solid or a gel. Preferably, the intermediate electrolyte layer is a gel and the ion-conducting polymer is a crosslinked polymer. By use of an intermediate electrolyte layer in solid or gel form, leakage of electrolyte material from the battery may be avoided.

The intermediate electrolyte layer does not comprise an n-type polymer or p-type polymer. The intermediate electrolyte layer may consist of the crosslinked polymer and the electrolyte, or may comprise one or more further materials. Optionally, the intermediate electrolyte layer comprises a plasticiser, optionally a glyme. Tetraglyme is particularly preferred.

The ion-conducting polymer may be a homopolymer or a copolymer comprising two or more different repeat units. Copolymers as described herein include alternating, random and block copolymers.

The ion-conducting polymer is preferably miscible with the electrolyte when in a liquid state or in solution. The ion-conducting polymer is preferably polar. The ion-conducting polymer is preferably a C₂₋₅ alkylene oxide polymer. More preferably, the ion-conducting polymer comprises or consists of crosslinked poly(ethylene oxide) (PEO).

Preferably, the ion-conducting polymer has a number average molecular weight in the range of about 5,000-100,000 Da, more preferably in the range of about 10,000-50,000 Da. The intermediate electrolyte layer may contain a mixture of ion-conducting polymers of different number average molecular weights.

The or each intermediate electrolyte layer may be formed from a solution or melt formulation containing the ion-conducting polymer, electrolyte and any other components of the layer. The solution or melt may be deposited directly onto an electrode layer. Suitable deposition methods include dip-coating or application with an applicator such as a brush or a rigid applicator such as a spatula.

In the case where the polymer of the intermediate electrolyte layer is crosslinked, the solution or melt may comprise a crosslinking initiator, for example a benzophenone, more preferably an alkylbenzophenone such as 4-methylbenzophenone, to crosslink the polymer. It will be understood that the polymer of the solution or melt is suitably not crosslinked until after the solution or melt has been deposited.

Crosslinking may be carried out by any suitable method including, without limitation, heat treatment and irradiation, preferably UV irradiation. Crosslinking may be performed after formation of an electrode stack.

Battery Formation

According to some embodiments, formation of a battery cell as described herein may include the following steps:
(i) Lamination of one or more freestanding anode films and an anode current collector.
(ii) Lamination of one or more freestanding cathode layer films and a cathode current collector.
(iii) Lamination of a separator comprising an electrolyte between the anode and cathode

Steps (i), (ii) and (iii) may occur in any sequence.

Step (i) may be replaced by another process for forming an anode on an anode current collector, for example by deposition of an anode formulation onto the anode current collector followed by evaporation of the solvent or solvents of the formulation.

Step (ii) may be replaced by another process for forming an anode on an anode current collector, for example by deposition of a cathode formulation onto the cathode current collector followed by evaporation of the solvent or solvents of the formulation.

According to other embodiments, one or more freestanding anode films and/or one or more freestanding cathode films may be laminated to the separator followed by lamination of the corresponding current collector to the combined electrode/separator structure.

It will be understood that a freestanding electrode film ceases to be freestanding following lamination to another structure, for example a current collector, separator or another freestanding electrode film.

Where an electrode is formed by lamination of one or more freestanding electrode films to a current collector or separator, it is preferred that the electrode is formed from a plurality of freestanding electrode films, optionally 2-15 freestanding electrode films, laminated together. The plurality of freestanding electrode films may be laminated sequentially onto the current collector or the separator or the plurality of freestanding electrode films may be laminated together before being laminated to the current collector or separator.

An electrode stack comprising a plurality of electrode layers formed from freestanding electrode films may be stored in airtight and/or watertight packaging before use.

An electrolyte in liquid form may be applied to one or both surfaces of freestanding electrode films before the films are laminated together. The presence of the electrolyte may enhance ionic conductivity of the electrode.

An electrode comprising one or more electrode layers formed from freestanding electrode films may consist of the one or more electrode layers or may comprise one or more additional layers. An “additional layer” as described herein does not contain an n-type polymer or p-type polymer. An exemplary additional layer is an electrolyte layer comprising an electrolyte, for example a solid or gel layer comprising or consisting of an electrolyte dispersed in a polymer. One or more electrolyte layers may be provided between electrode layers of an electrode.

In some embodiments, an electrode stack as described herein is formed by laminating one or more freestanding electrode layers together, with an electrolyte layer being provided between at least one pair of adjacent electrode layers of the stack.

Preferably, an electrode stack is preformed and then a separator and current collector are applied, in any order, to opposing ends of the stack. A preformed n-type or p-type electrode stack may comprise a protective film, suitably a protective polymer film, on one surface or on both opposing surfaces of the electrode stack wherein the protective film is removed prior to use of the electrode stack in formation of a battery. The electrode stack may be stored in airtight and/or watertight packaging, prior to use.

Where an electrode is formed by lamination of one or more freestanding electrode films to a current collector or separator, it is preferred that the electrode is formed from a plurality of freestanding electrode films, optionally 2-15 freestanding electrode films, laminated together. The plurality of freestanding electrode films may be laminated sequentially onto the current collector or the separator or the plurality of freestanding electrode films may be laminated together before being laminated to the current collector or separator.

The process of forming an electrode stack as described herein may include the step of squeezing together the layers of a stack comprising the electrode layers and at least one intermediate layer comprising polymer and electrolyte, for example by passing the stack through a laminating machine to squeeze out any excess material present in the electrolyte layer or layers, to adjust the electrolyte layer or layers to a desired thickness and/or to bring electrode layers spaced apart by the electrolyte layer or layers as applied into direct contact with one another. Squeezing is suitably performed when the layer comprising the polymer and electrolyte is in a state which is capable of flowing, for example a paste. If the polymer of the electrolyte layer or layers of the final electrode stack is crosslinked then crosslinking is performed after any squeezing step.

Electrolytes

An electrolyte as described anywhere herein, including as a component of an electrode layer, an intermediate layer or a separator, may be a dissolved salt or an ionic liquid. Preferably, electrolytes described herein are an ionic liquid.

The electrolyte may be a solution of a salt having an organic or metal cation, for example lithium bis(trifluoromethylsulfonyl)imide (LiTFSI) or lithium hexafluorophosphate, in an organic solvent, optionally propylene carbonate.

Ionic liquids as described herein may be ionic compounds that are liquid at below 100° C. and at 1 atm pressure. Examples include, without limitation, compounds with an ammonium-, imidazolium-, phosphonium-, pyridinium-, pyrrolidinium- or sulfonium cation. The ionic liquid may have a sulfonimide anion, for example bis(trifluoromethane)sulfonimide (TFSI) ionic liquids such as e.g. 1-ethyl-3-methyl imidazolium bis(trifluoromethane)sulfonimide (EMI-TFSI), triethylmethoxyethyl phosphonium bis(trifluoromethane)sulfonimide (TEMEP-TFSI), triethyl sulfonium bis(trifluoromethane)sulfonimide (TES-TFSI) or 1-butyl-1-methylpyrrolidinium bis(trifluoromethane)sulfonimide (BMP-TFSI), the latter being particularly preferable.

The freestanding anode and/or cathode layers described herein may contain an electrolyte, optionally in an amount of 10-30 wt % of the freestanding electrode film.

Conductive Carbon

Preferably at least one of the anode and cathode, and more preferably both of the anode and cathode, comprise one or more conductive carbon materials. Conductive carbon materials may be selected from, without limitation, one or more of the group consisting of carbon black, carbon fiber, graphite, and carbon nanotubes. Preferably, the BET specific surface area of the conductive carbon material is in the range of 10 m²/g to 3000 m²/g. Preferably, conductive carbon materials as described herein have an average diameter as measured by a scanning electron microscope of 50-100 nm. Preferably, carbon black is present in electrodes described herein, either alone or with one or more other forms of conductive carbon. Where present, a conductive carbon material may form 10-50 weight % of a freestanding electrode film.

n- and p-Type Polymers

n-type and p-type polymers as described herein are preferably conjugated polymers. A conjugated polymer as described herein comprises adjacent repeat units which are directly linked and conjugated to one another through conjugating groups of the repeat units. A conjugating group as described herein may be a non-aromatic double bond or triple bond, an aromatic group, a heteroaromatic group or an atom having a lone pair of electrons such as an N atom. The backbone of a conjugated polymer is conjugated along at least some of its length.

Preferably, at least 25 weight %, optionally at least 30 weight % or 40 weight % of a freestanding electrode layer as described herein is made up of an electrochemically active polymer, optionally 25-90 weight %.

An n-type polymer may comprise or consist of one or more 5-20 membered monocyclic or polycyclic heteroaromatic repeat units comprising one or more N atoms, and optionally one or more arylene repeat units. Heteroaromatic repeat units comprising one or more N atoms may comprise 0.1-99 mol % of the repeat units of the polymer, more preferably 10-75 mol %. Heteroaromatic repeat units comprising one or more N atoms. include, without limitation, pyridine, quinoline, benzothiadiazole, benzotriazole and triazine each of which may be unsubstituted or substituted with one or more substituents, optionally one or more substituents selected from R¹ as described above.

A particularly preferred heteroaromatic repeat unit is a repeat unit of formula (IV):

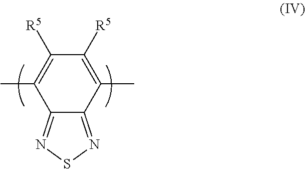

where: R⁵ in each occurrence is the same or different and is H or a substituent.

Optionally, each R⁵ is independently selected from the group consisting of: F, CN; NO₂; C₁₋₂₀ alkyl wherein one or more non-adjacent, non-terminal carbon atoms may be replaced with O, S, —Si(R⁹)₂— C═O or COO wherein R⁹ in each occurrence is independently a substituent, preferably a C₁₋₂₀ hydrocarbyl group; and a group of formula —(Ar¹)ₘ wherein Ar¹ in each occurrence is an aryl or heteroaryl group, preferably phenyl, which is unsubstituted or substituted with one or more substituents and m is at least 1, optionally 1, 2 or 3.

Substituents of Ar⁴, if present, are preferably selected from C₁₋₂₀ alkyl wherein one or more non-adjacent, non-terminal carbon atoms may be replaced with O, S, —Si(R⁹)₂— C═O or COO.

A p-type polymer may comprise or consist of one or more amine repeat units, and optionally one or more arylene repeat units. Amine repeat units of a p-type polymer suitably comprise a N atom in the polymer backbone, for example as disclosed in WO 99/54385, the contents of which are incorporated herein by reference.

Amine repeat units as described herein may have formula (V) or (VI):

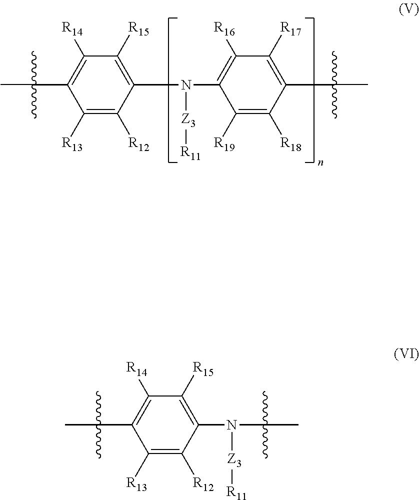

where: R₁₁ to R₁₉ are independently selected from hydrogen, C₁₋₂₀ alkyl, C₁₋₂₀-alkyl ether, C₁₋₂₀-carboxyl, C₁₋₂₀-carbonyl, C₁₋₂₀-ester, C₆₋₁₈-aryl, C₅₋₁₈-heteroaryl; n is greater than or equal to 1 and preferably 1 or 2; and Z₃ is selected from a single bond, C₁₋₂₀-alkylene, optionally substituted C₆₋₁₈-arylene, or an optionally substituted C₅₋₁₈-heteroarylene group.

In preferred embodiments, R₁₂ to R₁₉ are independently selected from hydrogen, C₁₋₁₂-alkyl, C₁₋₁₂-alkyl ether, C₁₋₁₂-carboxyl, C₁₋₁₂-carbonyl, C₁₋₁₂-ester, optionally substituted C₆₋₁₂-aryl, and optionally substituted C₅₋₁₂-heteroaryl groups; Z₃ is selected from a single bond, an optionally substituted C₁₋₁₂-alkylene, optionally substituted C₁₋₁₂-oxyalkylene, optionally substituted C₆₋₁₂-arylene, or an optionally substituted C₆₋₁₂-heteroarylene group. Where present, substituents of a C₆₋₁₂-arylene, or a C₆₋₁₂-heteroarylene group Z₃ are optionally selected from C₁₋₂₀ alkyl in which one or more non-adjacent, non-terminal C atoms may be replaced with O. In one embodiment, Z₃ is an optionally substituted phenylene group, with the residue RH being preferably an oligo- or polyether group having at least two alkoxy repeat units and being located in m- or p-position relative to the arylamino group.

A preferred amine repeat unit is 4,4′-linked triphenylamine which may be unsubstituted or substituted with one or more substituents as described above. Amine repeat units may make up 0.1-100 mol % of the repeat units of a p-type polymer, more preferably 10-75 mol %.

Arylene repeat units of n-type or p-type polymers include, without limitation, repeat units of formulae (VII)-(IX):

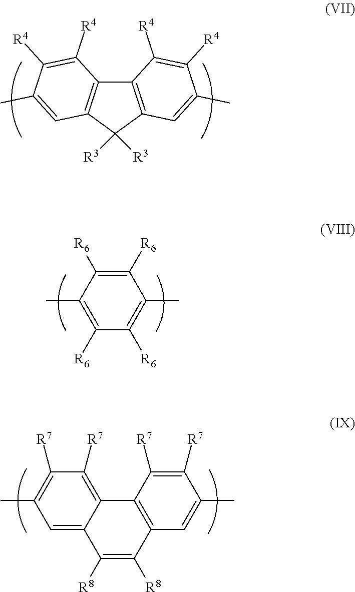

where: R³ in each occurrence is a substituent and R⁴, R⁶, R⁷ and R⁸ independently in each occurrence is H or a substituent.

Optionally, each R³ is selected from the group consisting of C₁₋₂₀ alkyl wherein one or more non-adjacent, non-terminal C atoms may be replaced with O, COO or CO; unsubstituted phenyl; and phenyl substituted with one or more C₁₋₁₂ alkyl groups wherein one or more non-adjacent, non-terminal C atoms of the alkyl groups may be replaced with O, COO or CO.

Optionally, R⁴, R⁶, R⁷ and R⁸ independently in each occurrence is H or a substituent selected from C₁₋₂₀ hydrocarbyl, optionally C₁₋₂₀ alkyl; unsubstituted phenyl; and phenyl substituted with one or more C₁₋₁₂ alkyl groups.

Polymers containing aromatic or heteroaromatic repeat units in the polymer backbone as described herein may be formed by methods including, without limitation, polymerisation of monomers comprising leaving groups (groups other than H) that leave upon polymerisation of the monomers; oxidative polymerisation; and direct (hetero)arylation. Exemplary leaving groups include, without limitation: halogens, preferably bromine or iodine; sulfonic esters, for example tosylate or mesylate; and boronic acids and esters.

Exemplary polymerisation methods include, without limitation, Yamamoto polymerization as described in, for example, T. Yamamoto, “Electrically Conducting And Thermally Stable pi-Conjugated Poly(arylene)s Prepared by Organometallic Processes”, Progress in Polymer Science 1993, 17, 1153-1205, the contents of which are incorporated herein by reference; Suzuki polymerization as described in, for example, WO 00/53656, WO 2003/035796, and U.S. Pat. No. 5,777,070, the contents of which are incorporated herein by reference; and direct (hetero)arylation as disclosed in, for example, Direct (Hetero)arylation Polymerization: Simplicity for Conjugated Polymers Synthesis”, Chem. Rev. 2016, 116, 14225-14274, the contents of which are incorporated herein by reference.

An n-type or p-type polymer as described herein may be a Schiff base polymer, for example a polymer comprising a repeat unit of formula (X):

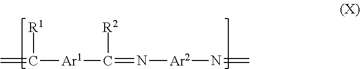

where: R¹ and R² are each independently selected from H or a substituent, optionally H, C₁₋₂₀ alkyl, and C₁₋₂₀ alkoxy; and Ar¹ and Ar² are each independently a C₆₋₂₀ aromatic or heteroaromatic group, preferably a C₆₋₂₀ arylene, optionally phenylene.

The n-type and p-type polymers as described herein preferably have a polystyrene-equivalent number-average molecular weight (Mn) measured by gel permeation chromatography in the range of about 1×10³ to 1×10⁸, and more preferably 1×10³ to 5×10⁶. The polystyrene-equivalent weight-average molecular weight (Mw) of the n-type and p-type polymers described herein may be 1×10³ to 1×10⁸, and preferably 1×10⁴ to 1×10⁷.

Separator

The separator may be selected from separators known to the skilled person. The separator comprises an electrolyte. The electrolyte may be a liquid, for example a gel comprising an electrolyte solution or a liquid electrolye. The separator may be a solid polymer electrolyte. The separator may comprise a mesh, for example a polymeric mesh, comprising electrolyte in the pores of the mesh.

Current Collectors

The anode and cathode current collectors each independently comprise or consist of a layer of conductive material, for example a metal such as copper or aluminium; a conductive organic polymer such as poly(ethylene dioxythiophene) or polyaniline; or an inorganic conductive compound such as a conductive metal oxide, for example indium tin oxide. Each current collector may be supported on a suitable substrate, for example a glass or plastic substrate. The substrates may be flexible, particularly for applications in which flexibility of the battery is desirable, and/or to enable use of a roll-to-roll process in battery formation. An exemplary flexible current collector is a metal foil, for example aluminium foil.

Applications

A battery as described herein may be used as a power source for any device, preferably for a portable device such as a phone, tablet or laptop, or a wearable device. A battery as described herein may be provided on a card, for example a debit, credit, prepayment or business card comprising an electrical device including, without limitation, a display, a speaker, a transmitter or a receiver.

Measurements

Square wave voltammetry measurements as described herein may be performed using a CHI660D Electrochemical workstation with software (IJ Cambria Scientific Ltd)), a CHI 104 3 mm glassy carbon disk working electrode (IJ Cambria Scientific Ltd)); a platinum wire auxiliary electrode; an Ag/AgCl reference electrode (Havard Apparatus Ltd); acetonitrile as cell solution solvent (Hi-dry anhydrous grade-ROMIL); toluene as sample preparation solvent (Hi-dry anhydrous grade); ferrocene as reference standard (FLUKA); and tetrabutylammoniumhexafluorophosphate (FLUKA) as cell solution salt. For sample preparation, the polymer is spun as thin film (˜20 nm) onto the working electrode. The measurement cell contains the electrolyte, a glassy carbon working electrode onto which the sample is coated as a thin film, a platinum counter electrode, and a Ag/AgCl reference glass electrode. Ferrocene is added into the cell at the end of the experiment as reference material (LUMO (ferrocene)=−4.8 eV).

Formulation Examples—Single Electrochemically Active Polymer

Formulations for forming n-type or p-type freestanding electrode films were formed by mixing n-type polymer F8BT or p-type polymer F8TFB respectively with Super P Conductive Carbon and ionic liquid 1-Butyl-1-methylpyrrolidinium bis(trifluoromethylsulfonyl)imide (BMP-TFSI) in a Polymer:Carbon:Ionic Liquid weight ratio of 1.0:0.8:0.2.

24 mg polymer and 19.2 mg carbon were mixed using a stirrer bar on a hotplate (70° C., 500 RPM), in a glass vial with 2 ml of o-dichlorobenzene (o-DCB), until a smooth paste was obtained. Then, using a micropipette, 5 mg of BMP-TFSI was added and mixed with the polymer: carbon paste for 10 minutes.

TABLE 1

| | HOMO | LUMO | Capacity | |
|---|---|---|---|---|
| Polymer | (eV) | (eV) | (mAh/g) | Type |
| F8BT | −5.85 | −2.91 | 51 | n-type |
| F8TFB | −5.2 | −.20 | 37.6 | p-type |
| SBP1 | −4.35 | −1.86 | 129.9 | n-type |

The polymer specific capacity (mAh/g) is calculated by dividing the measured capacity (mAh/cm²) by the redox polymer loading (g/cm²).

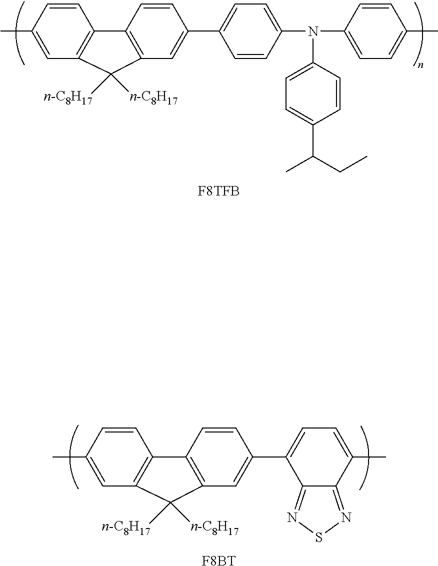

Formulation Examples—Two Electrochemically Active Polymers

The n-type formulations as described above were made except that Schiff Base Polymer 1 (SBP1) was included to give formulations containing both F8BT and SBP1.

TABLE 2

| | HOMO | LUMO | Capacity | |
|---|---|---|---|---|
| Polymer | (eV) | (eV) | (mAh/g) | Type |
| SBP1 | −4.35 | −1.86 | 129.9 | n-type |

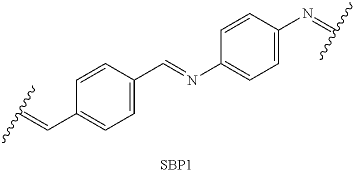

SBP1 was included so as to make up 10, 20 or 30 weight percent of the total weight of the n-type polymer as set out in the Table 3, the remaining n-type polymer weight being F8BT.

TABLE 3

| | | | Mass of | | |
|---|---|---|---|---|---|
| | Mass of | Mass of | Super P | Volume of | Volume of |
| | SBP1/ | F8BT/ | carbon/ | BMP-TFSI/ | o-DCB/ |
| Formulation | mg | mg | mg | μL | mL |
| 10% SBP1/ | 12 | 108 | 96 | 17 | 10 |
| F8BT | | | | | |
| 20% SBP1/ | 24 | 96 | 96 | 17 | 10 |
| F8BT | | | | | |
| 30% SBP1/ | 36 | 84 | 96 | 17 | 10 |
| F8BT | | | | | |

F8BT was dissolved in 10 mL o-DCB with stirring on a hotplate (70° C., 500 rpm) for 30 minutes until a homogeneous solution was obtained. Super P carbon and SBP1 were added, and the suspension was stirred for a further 30 minutes (70° C., 500 rpm). Using a micropipette, 17 μL of BMP-TFSI Ionic Liquid was added, and the suspension was stirred for an additional 30 minutes.

Freestanding Electrode Films

Freestanding n-type and p-type electrode layers were formed from the formulations described above.

In each case, 2 ml of the formulation suspension was pipetted onto a smooth substrate of Al on glass which was placed on a hotplate at 70° C. The formulation was allowed to dry to form a 40 micron thick film and was then removed from the substrate.

The films were cut to a 1×1.5 cm area, transferred to a glovebox and baked at 150 C for 30 minutes to remove any residual moisture.

Battery Formation—Single Electrochemically Active Polymer

1-6 freestanding electrode films selected from one of n-type (F8TFB) and p-type (F8BT) freestanding electrode films of were placed on a current collector of thermally evaporated aluminium on glass, with BMP-TFSI being applied between the films.

A separator of filter paper (vacuum oven dried) soaked in BMP-TFSI was placed on top of the electrode layer or layers.

A number of the other of n-type and p-type freestanding electrode films were placed on the separator, the number of layers being the same as the number of layers for the other electrode (i.e. between 1 and 6) with BMP-TFSI being applied between the films and the device was completed by placing a current collector of aluminium on glass thereon.

The layers of the device were held together with a clip. Batteries were placed in a sealed container under an inert atmosphere and connected to an Arbin battery tester (Model—BT2043).

Test parameters:
Cathodic current 1.0 mA cm⁻² (discharge current) & Anodic current 1.0 mA cm⁻² (charging current)
Charging potential 3 V & High potential hold time: 600 s
Active area 1.5 cm² & End voltage 0 V

The charge-discharge sequence was repeated 100 times, and the midpoint voltage and charge capacity calculated for each cycle. The midpoint voltage is defined as the voltage at t/2, where t is the total discharge time of the battery for a given cycle. Charge capacity (expressed in units of mAh cm⁻²) is calculated as the time required to discharge to the end voltage multiplied by the cathodic current, and divided by the active area.

With reference to Table 4, charge capacity increases with the number of freestanding electrode films used to form the electrodes of the battery.

TABLE 4

| Number of | | | | | |
|---|---|---|---|---|---|
| anode and | Max | | Max | Average | Material |
| cathode | capacity | | voltage | voltage | utilisation |
| layers | (mAh/g) | T80 | (V) | (V) | % n/p |
| 1 | 0.02 | 241 | 1.97 | 1.97 | 59/92 |
| 2 | 0.05 | 101 | 1.94 | 1.88 | 58/91 |
| 4 | 0.08 | 140 | 1.82 | 1.64 | 53/83 |
| 6 | 0.10 | 139 | 1.80 | 1.56 | 35/46.4 |

The material utilisation (in percent) is the ratio of measured polymer specific capacity (mAh/g) over the maximum theoretical specific capacity (mAh/g).

Battery Formation—Two Electrochemically Active Polymers

Three batteries were formed as described above with an anode formed by lamination of two freestanding anode films and a cathode formed from a single freestanding anode film of F8TFB.

The freestanding anode films contained the following weight ratios of n-type polymers:

F8BT (100); F8BT (90):SBP1 (10); and F8BT (80):SBP1 (20)

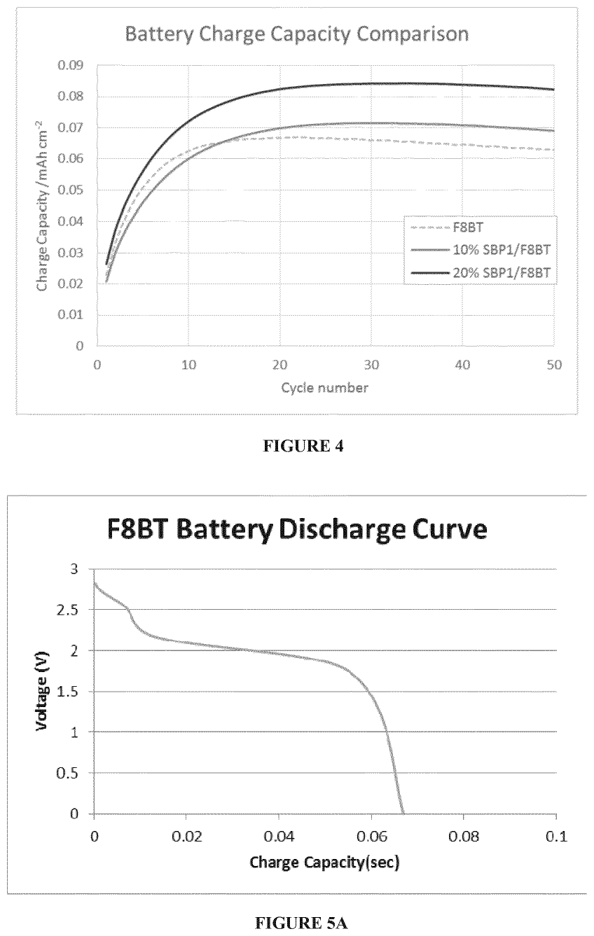

With reference to FIG. 4, the maximum charge capacity increases with increased loading of SBP1.

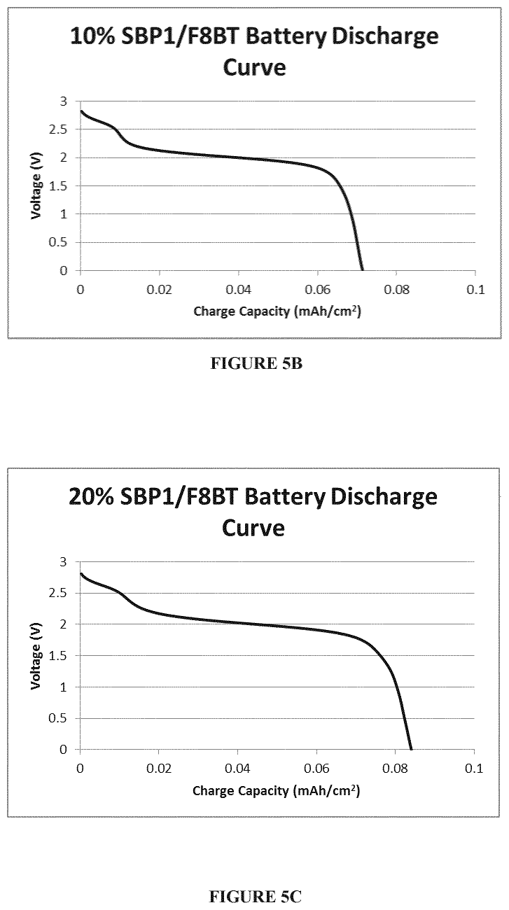

With reference to FIGS. 5A-5C, the discharge curves of the batteries were similar, with similar midpoint voltages.

Electrode Stack Formation

In some embodiments, electrode stacks are formed from multiple freestanding electrode layers.

1.00 g of poly(ethylene glycol) methyl ether (PEO), average Mn 20,000, obtained from Sigma-Aldrich, 1.0 mL of tetraglyme (TG) obtained from Sigma Aldrich, 0.21 g of 4-methylbenzophenone (MBP) obtained from Sigma Aldrich and 2.0 mL of 1-Butyl-1-methylpyrrolidinium bis(trifluoromethylsulfonyl)imide (BMP-TFSI) obtained from Solvionic were mixed in a pestle and mortar at 120° C. until the PEO and MBP fully melted and a viscous liquid formed, giving a mixture having a PEO(20 k):TG:MBP:BMP-TFSI weight ratio of 1:1:0.2:2.8.

The molten mixture was deposited in an approximately 2 cm diameter circle on a 50 micron thick sheet of polyethylene terephthalate (PET), obtained from 3M and allowed to cool to form a gel electrolyte layer. A protective film on the PET as supplied was removed before use, however the molten mixture was deposited on the PET surface opposing the protected surface.

A first freestanding n-type or p-type electrode film, cut to a rectangular shape of approximately 1×1.5 cm, was placed onto the gel electrolyte layer with the surface of the freestanding electrode film which was in contact with the film-forming substrate being brought into contact with the gel electrolyte layer.

The molten PEO(20 k):TG:MBP:BMP-TFSI mixture was applied to the upper surface of the electrode film and spread with a spatula such that the whole of the upper surface was wetted by the molten mixture to form a second gel electrolyte layer.

A second freestanding electrode film was place on the second gel electrolyte layer and in alignment with the first electrode film. This layering was repeated to form a stack having 2-5 electrode layers and in which the outermost layers were both gel electrolyte layers.

A second sheet of PET was applied to the top of the stack which was then squeezed between two hotplates at 120° C. to melt the PEO, TG and MBP and to cause any excess of these materials to be squeezed out of the stack.

The stack was passed through a laminating machine at 100° C. and then cured with UV light (250 W UVH 255 hand lamp with an iron-doped metal halide lamp, intensity >80 mW cm⁻²) for 6 minutes either side under an inert, dry atmosphere.

Both n-type electrode stacks and p-type electrode stacks were formed according to this process.

Separator Formation

PEO(100 k), PEO(20 k), tetraglyme, MBP and ionic liquid BMP-TFSI in a 3:1:4:0.8:11.2 weight ratio was prepared by mixing 0.25 g of PEO(20 k), 1.0 mL of tetraglyme, 0.21 g of MBP and 2.0 mL of BMP-TFSI per gram of PEO in a pestle and mortar at 120° C. until the PEO(20 k) fully melted and a viscous liquid formed. 0.75 g of PEO(100 k) was added, and the mixture was stirred until the PEO(100 k) fully melted and highly viscous paste formed.

The molten polymer mix was deposited in a roughly 6 cm diameter circle on the back side of a 50 μm thick sheet of PET. A 47 mm diameter hydrophilic nylon net filter with a 41.0 μm pore size available from Merck Millipore (part number NY4104700) was placed on top of the deposited molten polymer mixture. Another sheet of PET was placed on top of the nylon mesh.

The PET-polymer-nylon-PET sandwich was pressed between two hot plates heated to 120° C. and then laminated at 100° C. to form a thin film of the melt evenly distributed in the pores of the nylon mesh. Without removing the PET sheets, the polymer mixture was cured using UV light (250 W UVH 255 hand lamp with an iron-doped metal halide lamp, intensity >80 mW cm²) for 6 minutes either side under an inert, dry atmosphere. The resulting gel/nylon composite separator was cut to size (3×2 cm) and then peeled off the PET substrate to give a film having a thickness of between 40-65 μm.

Electrode Stack Battery Example 1

One sheet of PET was removed from the electrode stack described above and the gel/nylon composite separator was placed on top of the stack. The other of the n-type and p-type electrode stacks, again containing five electrode layers, was placed on the opposing surface of the separator. This anode/separator/cathode structure sandwiched by PET sheets was passed through a laminating machine at 100° C. The PET sheets were removed and each electrode stack was brought into contact with an aluminium current collector supported on a glass substrate. The completed structure was secured with clips.

Comparative Device 1

For the purpose of comparison, a device was formed as described above except that the anode and cathode electrodes were formed from a stack of, respectively, the n-type and p-type freestanding electrode films described above, without any intervening gel electrolyte layers.

Electrode Stack Battery Example 2

A battery was prepared as described for Electrode Stack Battery Example 1 except that PEO 20,000 Mn used in the intermediate gel electrolyte layers was replaced with a 3:1 w/w mixture of PEO 20,000 Mn:PEO 100,000 Mn.

Batteries were placed in a sealed container under an inert atmosphere and connected to an Arbin battery tester (Model—BT2043).

Test parameters: Cathodic current 1.0 mA cm⁻² (discharge current); Anodic current 1.0 mA cm⁻² (charging current); Charging potential 3V; High potential hold time 600 s; Active area 1.5 cm²; and End voltage 0 V

The charge-discharge sequence was repeated 100 times, and the midpoint voltage and charge capacity calculated for each cycle. The midpoint voltage is defined as the voltage at t/2, where t is the total discharge time of the battery for a given cycle. Charge capacity (expressed in units of mAh cm⁻²) is calculated as the time required to discharge to the end voltage multiplied by the cathodic current, and divided by the active area.

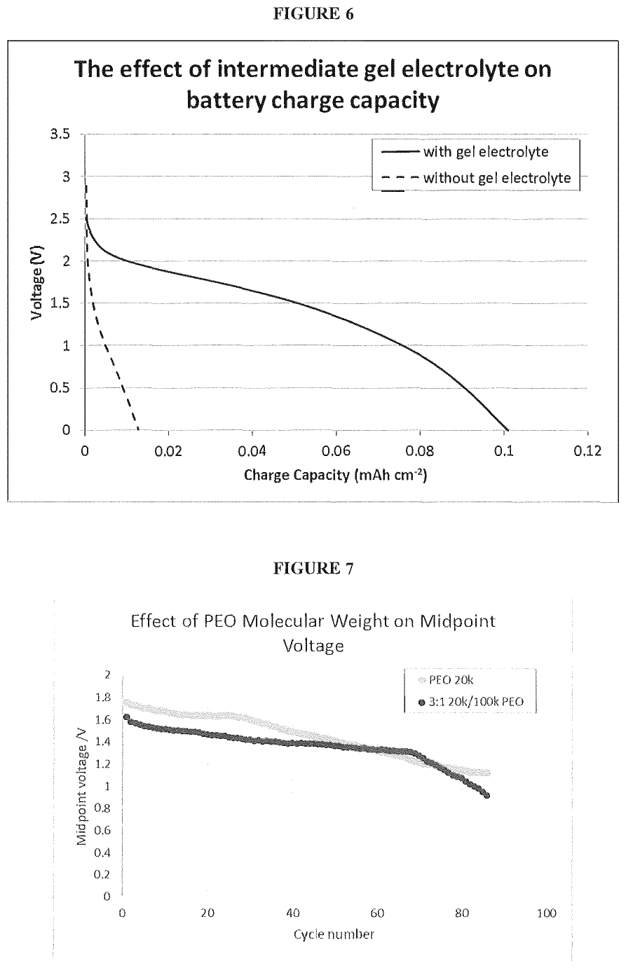

With reference to FIG. 6, the time required to discharge to 0 V is much greater for the battery containing intermediate gel electrolyte layers as compared to the comparative battery without such layers.

With reference to table 5, charge capacity and midpoint voltage of the exemplary battery is much higher than that of the comparative battery

TABLE 5

| Battery | Charge capacity/mAh cm⁻² | Mid-point voltage/V |
|---|---|---|
| Example | 0.006 | 0.8 |
| Comparative | 0.048 | 1.8 |

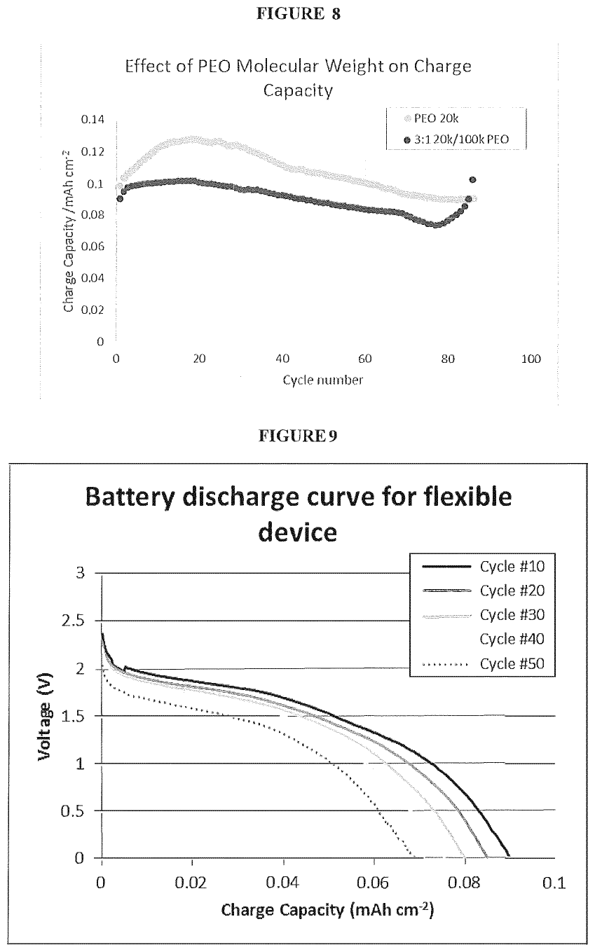

With reference to FIGS. 7 and 8 and Table 6, midpoint voltage, charge capacity is higher and charging resistance is lower for Battery Example 1 containing PEO having a lower Mn value.

TABLE 6

| | Charge capacity/ | Midpoint | Charging |
|---|---|---|---|
| Battery | mAh cm⁻² | voltage/V | resistance/Ω |
| Example 2 | 0.1023 | 1.62 | 114 |
| Example 1 | 0.1278 | 1.76 | 65 |

Electrode Stack Battery Example 3

An electrode stack battery was prepared as described for Electrode Stack Battery Example 1 except that the laminated electrode/separator/electrode structure was placed between aluminium foil current collectors, and the completed structure was placed in a lamination pouch and laminated by passing it through a laminator at 100 C. The size and positions of the current collectors were selected such that the two current collectors did not contact one another either in the battery area (as a result of being spaced apart by the separator) or outside the battery area (as a result of the positioning of the current collectors such that they do not overlap outside the battery area). Copper tape was applied over holes in the lamination pouch to contact the aluminium current collectors, thereby sealing the battery and providing an electrical connection thereto.

Electrode Stack_Battery Example 3 was tested as described above except that testing was performed under ambient atmospheric conditions rather than in a sealed container under an inert atmosphere.

With reference to FIG. 9, a functional battery was obtained with good cycling characteristics demonstrating effectiveness of the flexible encapsulation.

Although the invention has been described in terms of specific exemplary embodiments, it will be appreciated that various modifications, alterations and/or combinations of features disclosed herein will be apparent to those skilled in the art without departing from the scope of the invention as set forth in the following claims.

1. A freestanding composite electrode film comprising 25-90 weight % of an n-type or p-type electrochemically active polymer and at least one of an electrolyte and a conductive carbon material.

2-3. (canceled)

4. A freestanding composite electrode film according to claim 1 wherein the film comprises the conductive carbon material.

5. A freestanding composite electrode film according to claim 4 wherein the conductive carbon material is selected from the group consisting of carbon black, carbon fiber, graphite, and carbon nanotubes.

6. A freestanding composite electrode film according to claim 1 wherein the film comprises the electrolyte.

7. A freestanding composite electrode film according to claim 6 wherein the electrolyte is an ionic liquid.

8. A freestanding composite electrode film according to claim 7 wherein the ionic liquid is 1-butyl-1-methylpyrrolidinium bis(trifluoromethane) sulfonimide.

9. A freestanding composite electrode film according to claim 1 wherein the film has a thickness in the range of 10-100 microns.

10. A method of forming a freestanding composite electrode film according to claim 1, the method comprising the step of depositing a formulation comprising the n-type or p-type electrochemically active polymer and one or both of the electrolyte and the conductive carbon material dissolved or dispersed in one or more solvents onto a surface of a film forming substrate; evaporating the solvent or solvents to form a film; and separating the film from the film forming substrate.

11. A method of forming a battery comprising an anode comprising an n-type polymer, a cathode comprising a p-type polymer; a separator between the anode and the cathode; an anode current collector; and a cathode current collector, wherein the anode comprises at least one anode layer formed by lamination of, a freestanding composite anode or cathode film according to claim 1.

12. A method according to claim 11 wherein the anode comprises an anode stack comprising a plurality of the anode layers.

13. A method according to claim 12 wherein an electrolyte is applied to a surface of a partially formed anode stack or to a freestanding anode film before lamination of the freestanding anode film to the partially formed anode stack.

14. A method according to claim 12 wherein formation of the anode stack comprises building the stack by lamination of the freestanding anode films to the separator or to, the anode current collector.

15. A method according to claim 12 wherein a preformed anode stack is laminated to the separator or to, the anode current collector.

16. A method according to claim 11 wherein the anode comprises at least one anode layer formed by lamination of a composite anode film and the cathode comprises at least one cathode layer formed by lamination of a composite cathode film comprising 25-90 weight % of an p-type electrochemically active polymer and at least one of an electrolyte and a conductive carbon material.

17. A method according to claim 11 wherein the freestanding composite electrode film comprises an electrolyte which is the same as an electrolyte comprised in the separator.

18. A battery obtainable by method according to claim 11.

19. A battery comprising an anode comprising an n-type polymer, a cathode comprising a p-type polymer; a separator between the anode and the cathode; an anode current collector; and a cathode current collector, wherein the anode comprises an electrode stack comprising a plurality of electrode layers, each electrode layer comprising 25-90 weight % of an n-type electrochemically active polymer and at least one of an electrolyte and a conductive carbon material.

20. A frestanding composite electrode film comprising 25-90 weight % of an n-type or p-type electrochemically active polymer and an ionic liquid electrolyte.

21. A freestanding composite electrode film according to claim 20 further comprising a conductive carbon material.
